(19) United States
(12) Patent Application Publication
(10) Pub. No.: US 2019/0323408 A1
(43) Pub. Date: Oct. 24, 2019

(54) Method For Testing The Functional Soundness Of A Particle Sensor

(71) Applicant: CONTINENTAL AUTOMOTIVE GmbH, Hannover (DE)

(72) Inventor: Hong ZHANG, Tegernheim (DE)

(21) Appl. No.: 16/312,957

(22) PCT Filed: Mar. 22, 2017
(86) PCT No.: PCT/EP2017/056804

§ 371 Date: Dec. 21, 2018

(30) Foreign Application Priority Data
Jun. 29, 2016 (DE) 10 2016 211 712.2

(51) Int. Cl. F01N 11/00; G01N 15/06

(52) U.S. Cl. CPC F01N 11/002; G01N 15/06; F01N 2560/05; F01N 2900/1606; F01N 2560/14; F01N 2900/0416; F01N 2900/1406; F01N 2560/08

(57) ABSTRACT

A method for testing a particle sensor arranged in an exhaust train having a particle filter for capturing particles, a differential pressure sensor for sensing a differential pressure at the particle filter between a pressure upstream of the particle filter and a pressure downstream of the particle filter, and a particle sensor downstream of the particle filter and designed to sense the quantity of particles in the exhaust gas. The method includes sensing a quantity of particles in the exhaust gas by means of the particle sensor, determining that the sensed quantity of particles is greater than a predetermined upper threshold value, sensing a differential pressure at the particle filter by the differential pressure sensor and determining that the particle sensor is not functionally capable if the sensed differential pressure is higher than a predetermined upper pressure threshold value.

### CROSS REFERENCE TO RELATED APPLICATIONS

This is a U.S. national stage of application No. PCT/EP2017/056804, filed on Mar. 22, 2017. Priority is claimed on German Application No. DE102016211712.2, filed Jun. 29, 2016, the content of which is incorporated here by reference.

### BACKGROUND OF THE INVENTION

### 1. Field of the Invention

The present invention relates to a method for testing the functional capability of a particle sensor arranged in an exhaust train of an internal combustion engine, in particular to a method for testing the plausibility of a signal of a particle sensor of an internal combustion engine.

### 2. Description of the Prior Art

The reduction of exhaust gas emissions in motor vehicles is an important objective when developing new motor vehicles. Therefore, combustion processes in internal combustion engines are optimized thermodynamically so that the efficiency of the internal combustion engine is significantly improved. In the field of motor vehicles, diesel engines are being increasingly used which, in a modern design, have very high efficiency. However, the disadvantage of this combustion technology compared to optimized spark ignition engines is the emission of soot and/or particles. Soot and/or particles have a highly carcinogenic effect owing to the polycyclic aromatics, which has already prompted various regulations. For example, exhaust gas emission standards with maximum limits for the emissions of soot have been issued. In order to be able to satisfy the exhaust gas emission standards over a wide area for motor vehicles with diesel engines, there is a need to manufacture cost-effective sensors that reliably measure the soot content in the exhaust gas stream of the motor vehicle.

Soot sensors measure the currently emitted soot and/or quantity of particles so that the engine management system in a motor vehicle can be provided with information in a current driving situation to reduce the emission values through technical control adjustments. Moreover, the soot sensors can be used to initiate active exhaust gas purification by exhaust gas soot filters or exhaust gas recirculation to the internal combustion engine. In the case of soot filtering, filters which can be regenerated, such as for example particle filters, and which filter out and capture a significant part of the soot content from the exhaust gas are used. Soot sensors are required for the detection of soot in order to monitor the function of the soot filters or in order to control their regeneration cycles. For this purpose, a soot sensor can be connected upstream and/or downstream of the soot filter, which is also referred to as a diesel particle filter.

The soot sensor or particle sensor, which is connected upstream of the particle filter, serves to increase the reliability of the system and to ensure operation of the particle filter under optimum conditions. Since this depends to a large degree on the quantity of particles trapped in the particle filter, precise measurement of the particle concentration upstream of the particle filter system, in particular the determination of a high particle concentration upstream of the particle filter, is highly significant.

A soot sensor or particle sensor, which is connected downstream of the particle filter, provides the possibility of performing vehicle-specific diagnostics and also serves to ensure the correct operation of the exhaust gas after-treatment system.

The prior art presents various approaches to detecting soot and particles. An approach which is widely adopted in laboratories is to use scattering of light by the soot particles. This procedure is suitable for complex measuring devices. If it is attempted also to use this as a mobile sensor system in the exhaust train, it must be borne in mind that approaches from implementing an optical sensor in a motor vehicle entail very high costs. Furthermore, there are unresolved problems with respect to the contamination of the required optical windows by combustion exhaust gases.

U.S. Pat. Nos. 8,261,540 B2, 8,127,592 B2, 7,866,146 B2 and US 2008/0087101 A1 disclose particle sensors and exhaust gas purification devices.

If a particle sensor, which is connected downstream, displays a signal that indicates a predetermined quantity of particles in the exhaust gas downstream of a particle filter, this can either point to a defect in the particle filter or to a defect in the particle sensor. That is to say there can be no reliable statement made here as to whether the signal of the particle sensor is plausible or not.

### SUMMARY OF THE INVENTION

It is an object of one aspect of the present invention to make available a method for testing the functional capability of particle sensor arranged in an exhaust train of an internal combustion engine of a vehicle and with which the plausibility of the signals of the particle sensor can be monitored and evaluated.

One aspect of the invention is essentially based on the concept that the plausibility of the signal of a particle filter is tested by a differential pressure signal of a differential pressure sensor at a particle filter. If the signal of the particle sensor is in an increased range but the differential pressure at the particle filter is in a predetermined range, in which it can be assumed that the particle filter is operating correctly, it can be assumed that the particle sensor is faulty and consequently the signals of the particle sensor are invalid. By testing the plausibility of the signal of the particle sensor by the differential pressure signal at the particle filter, it is therefore possible to enable and subsequently carry out a functional diagnosis of the particle filter.

Accordingly, a method for testing the functional capability of a particle sensor arranged in an exhaust train of an internal combustion engine of a vehicle is disclosed. The internal combustion engine has a particle filter for at least partially capturing particles and/or soot in the exhaust gas, a differential pressure sensor for sensing a differential pressure at the particle filter between a pressure upstream of the particle filter and a pressure downstream of the particle filter, and a particle sensor arranged downstream of the particle filter and designed to sense the residual quantity of particles located in the exhaust gas. A method according to one aspect of the invention comprises sensing a quantity of particles in the exhaust gas by the particle sensor, determining that the sensed quantity of particles is greater than a predetermined upper threshold value of the quantity of particles, sensing a differential pressure at the particle filter by the differential pressure sensor, and determining that the particle sensor is not functionally capable if the sensed differential pressure is higher than a predetermined upper pressure threshold value.

In the case of a correctly operating particle filter, the differential pressure increases in proportion with the loading of the particle filter. That is to say, if the sensed differential pressure is higher than a predetermined upper pressure threshold value, it can be assumed that the particle filter is operating correctly. At the same time, in the case of a particle sensor signal that indicates a quantity of particles in the exhaust gas greater than a predetermined upper threshold value of the quantity of particles, it can be assumed that a faulty particle sensor is present and the latter is therefore generating faulty or invalid sensor signals.

According to one preferred refinement of the method according to the invention, there is further provision of burning off of particles in and/or at the particle sensor if it is determined that the particle sensor is not functionally capable, sensing of a quantity of particles in the exhaust gas by the particle sensor after the burning off of particles in and/or at the particle sensor, and determining that the particle sensor is functionally capable again if the quantity of particles sensed after the burning off of particles in and/or at the particle sensor is smaller than the predetermined upper threshold value of the quantity of particles.

As a result of the burning off and subsequent renewed sensing of a quantity of particles in the exhaust gas it can be determined whether the previously detected faulty signal results from an excessively loaded particle sensor. The particles in an excessively loaded particle sensor can in fact cause a short circuit, since the particles can produce an electrical connection between the electrodes. As result of the burning off it is therefore possible to prevent the faulty signal from resulting in a short circuit.

In a similar way, after the burning off of particles in and/or at the particle sensor and the subsequent renewed sensing of a quantity of particles in the exhaust gas, it can be determined that the particle sensor is faulty if the quantity of particles sensed after the burning off of particles in and/or at the particle sensor is greater than the predetermined upper threshold value of the quantity of particles. In this case it can be inferred that despite a functionally capable particle filter, the particle sensor signal continues to indicate a value that does not correspond to reality and is in a predetermined range. Therefore, the particle sensor can be diagnosed as being faulty.

In a further advantageous refinement of the method according to the invention, there is also provision of carrying out a functional investigation of the particle filter if the sensed differential pressure is lower than the predetermined upper pressure threshold value. Such a functional investigation of the particle filter should, in fact, not be carried out until the signal of the particle sensor is satisfactory, i.e. if the particle sensor is functionally capable.

According to a second aspect, a method according to the invention for testing the functional capability of a particle sensor arranged in an exhaust train of an internal combustion engine of a vehicle is disclosed. The internal combustion engine has a particle filter for at least partially capturing particles in the exhaust gas, a differential pressure sensor for sensing a differential pressure at the particle filter between a pressure upstream of the particle filter and a pressure downstream of the particle filter, and a particle sensor arranged downstream of the particle filter and designed to sense the residual quantity of particles located in the exhaust gas. The method according to the invention comprises, according to the second aspect, sensing a differential pressure at the particle filter by the differential pressure sensor, determining that the sensed differential pressure is lower than a lower pressure threshold value, sensing a quantity of particles in the exhaust gas by the particle sensor and determining that the particle sensor is not functionally capable if the sensed quantity of particles is smaller than a predetermined lower threshold value of the quantity of particles.

In the method according to the invention according to the second aspect, the differential pressure signal of the differential pressure sensor is evaluated. When the lower pressure threshold value is exceeded, it can be assumed that the particle filter is operating correctly. If the sensed differential pressure is below the lower pressure threshold value, it can be assumed that the particle filter is not operating correctly and, for example, has a hole which is responsible for the drop in pressure. In addition, at the same time the particle sensor signal is tested to determine whether it indicates a value that exceeds a lower threshold value of the quantity of particles or not. If the quantity of particles indicated by the particle sensor signal remains below the lower threshold value of the quantity of particles, it can be assumed that the sensor is faulty and is not operating correctly.

When there is a known exhaust gas mass flow and a load of the particle filter that has been calculated by a model, the anticipated differential pressure at the particle filter can be calculated. If the differential pressure is therefore outside, in particular below, an anticipated pressure range, it can be assumed that the particle filter is at least partially defective.

Furthermore, it is preferred that at the same time it can be determined that the particle sensor is functionally capable if the sensed quantity of particles is greater than the predetermined lower threshold value of the quantity of particles. The particle filter diagnosis also cannot be enabled here by means of the particle sensor until a functionally capable particle sensor has been diagnosed.

The predetermined upper pressure threshold value and/or the predetermined lower pressure threshold value are advantageously predetermined as a function of the exhaust mass flow located in the exhaust train and/or the current load state of the particle filter. For example, for this purpose an air mass flow rate meter is provided in the intake section, and a load state meter is provided in the exhaust train, at the particle filter. The exhaust gas mass flow can be calculated by the air mass meter using a continuity equation, and the load state can be alternatively determined by a model.

In a further advantageous refinement of the method according to the invention, the predetermined upper threshold value of the quantity of particles and/or the predetermined lower threshold value of the quantity of particles are predetermined as a function of the exhaust mass flow located in the exhaust train and/or the particle quantity raw emissions. The particle raw emissions can either be calculated by a model or sensed by a particle sensor.

According to a further aspect of the present invention, a computer program product is disclosed that has a computer-readable medium and a program code stored on the computer-readable medium which, when it is executed on a control unit, induces the control unit to execute a method according to the invention.

In addition, an exhaust train for an internal combustion engine is disclosed, which exhaust train has a particle filter for at least partially capturing particles in the exhaust gas, a differential pressure sensor for sensing a differential pressure at the particle filter between a pressure upstream of the particle filter and a pressure downstream of the particle filter, a particle sensor arranged downstream of the particle filter and has the purpose of sensing the residual quantity of particles located in the exhaust gas, and a control unit designed to obtain the signals of the differential pressure sensor and the quantities of particles sensed by the particle sensor and to execute a method for testing the functional capability of the particle sensor according to one of the methods according to the invention.

Within the scope of the present disclosure, reference is made to various sensors which each sense different parameters. During the sensing of different parameters, the respective sensor firstly generates a signal that indicates the respective value of the parameter. In this context, the linking between the sensor signal and the parameter value can occur by a suitable algorithm and/or a look up table. At this point it is explicitly stated that the methods described herein can be executed both directly by the sensor signals or by the respective assigned parameter values.

### BRIEF DESCRIPTION OF THE DRAWINGS

Further features and objects of the invention will become apparent to a person skilled in the art by practicing the present teaching and taking into consideration the appended drawings, in which:

FIG. 1 is a schematic flow chart of a method according the invention, and

FIG. 2 is a schematic flow chart of a method according the invention.

### DETAILED DESCRIPTION OF THE PRESENTLY PREFERRED EMBODIMENTS

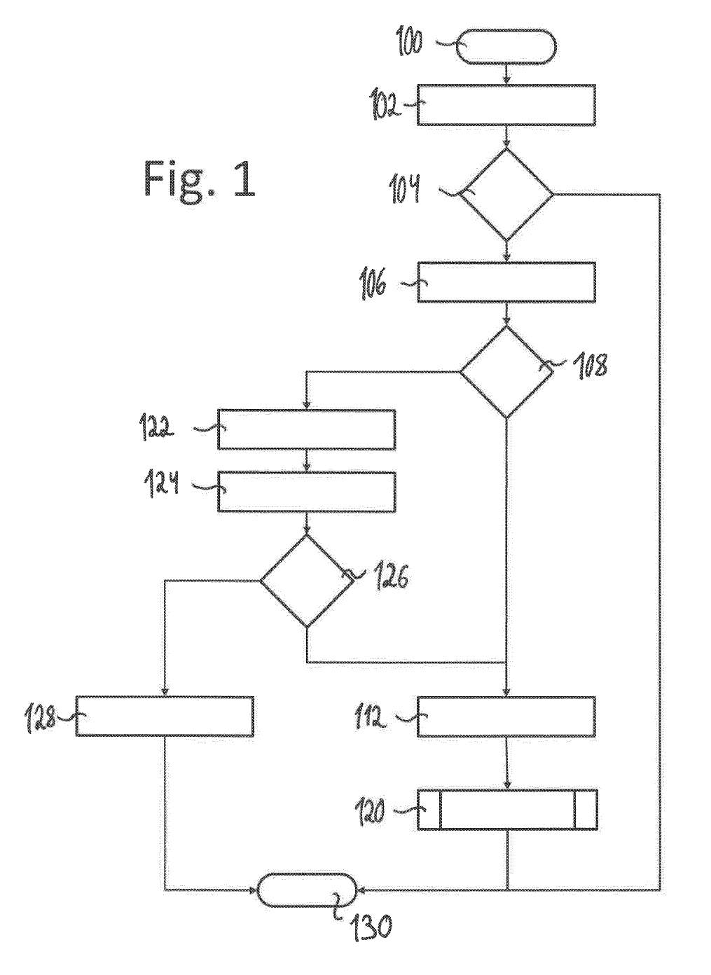

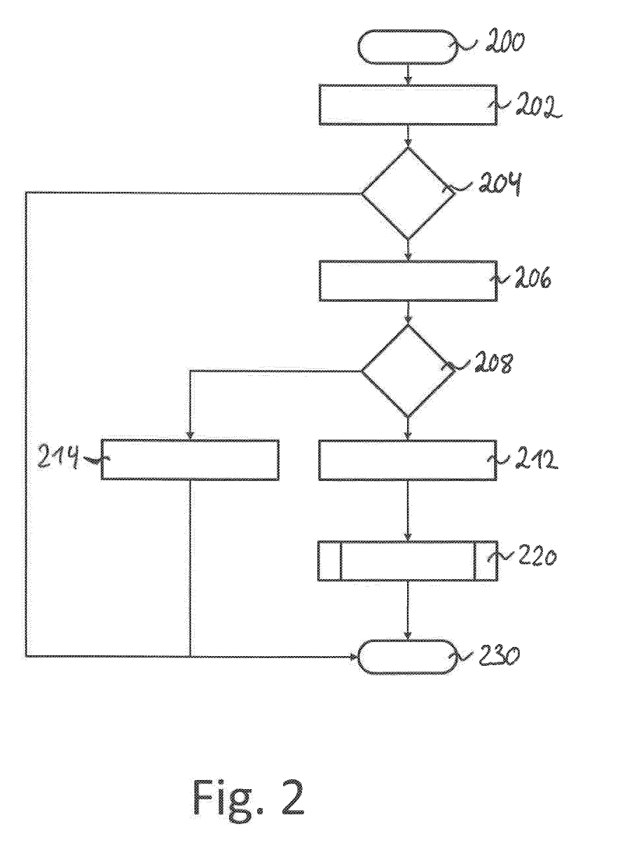

The flow charts illustrated in FIGS. 1 and 2 relate to a method for testing the functional capability of a particle sensor arranged in an exhaust train of an internal combustion engine of a vehicle. The internal combustion engine, for example a diesel engine, has a particle filter, such as e.g. a diesel particle filter, for at least partially capturing particles, such as diesel particles, in the exhaust gas, a differential pressure sensor for sensing a differential pressure at the particle filter between a pressure upstream of the particle filter and a pressure downstream of the particle filter, and a particle sensor arranged downstream of the particle filter and is designed to sense the residual quantity of particles located in the exhaust gas.

The method according to FIG. 1 begins with step 100 and then passes to step 102, in which a quantity of particles in the exhaust gas is sensed by the particle sensor. In particular, the particle sensor generates a signal that indicates a corresponding value of the residual quantity of particles in the exhaust gas.

During the subsequent step 104 it is determined whether the sensed quantity of particles is greater than a predetermined upper threshold value of the quantity of particles. This means that the signal that is output by the particle sensor indicates a particle quantity value that is too high for the present operating state of the internal combustion engine.

If it is determined at step 104 that the sensed quantity of particles is smaller than the predetermined upper threshold value of the quantity of particles, the method reaches step 130 and is terminated. However, if it is determined at step 104 that the sensed quantity of particles is greater than a predetermined upper threshold value of the quantity of particles, the method continues with step 106.

At step 106, a differential pressure at the particle filter is sensed by the differential pressure sensor. This sensed differential pressure value is evaluated at the subsequent step 108.

If it is determined at step 108 that the sensed differential pressure is lower than a predetermined upper pressure threshold value, the method proceeds to step 112 at which it is determined that the particle sensor is functionally capable and is operating correctly. In a subsequent step 120, a diagnosis of the particle filter can then be carried out by the signal of the particle sensor, which is diagnosed as valid. The method subsequently ends at step 130.

However, if it is determined at step 108 that the particle sensor is not functionally capable, i.e. that the sensed differential pressure is higher than the predetermined upper pressure threshold value, the method proceeds to step 122 at which particles are burnt off the particle sensor. This can be done, for example, by a heater arranged in and/or at the particle sensor being heated to a temperature of, for example, over 600° C., as a result of which all of the particles that have adhered to the particle sensor burnt off. Alternatively or additionally, the burning off of the particles in and/or at the particle sensor can take place by a regeneration process of the particle filter.

In the subsequent step 124, a quantity of particles in the exhaust gas is sensed again by the particle sensor, and the quantity is evaluated in the subsequent step 126.

If it is determined in step 126 that the particle sensor is functionally capable again, i.e. that the quantity of particles sensed after the burning off of particles in and/or at the particle sensor is smaller than the predetermined upper threshold value of the quantity of particles, the method proceeds to step 112, and the particle sensor is detected again as being functionally capable. Here the method continues in turn with the previously described step 120 and ends at step 130.

However, if it is determined in step 126 that the particle sensor is not functionally capable, i.e. that the quantity of particles sensed after the burning off of particles in and/or at the particle sensor is greater than the predetermined upper threshold value of the quantity of particles, the method proceeds to step 128, and the particle sensor is diagnosed as not being functionally capable. At this point, diagnosis of the particle filter must or should not be carried out using the particle sensor, for which reason the method according to FIG. 1 in accordance with step 128 should be ended at step 130. In this case, the step 120 is not executed, since the signal of the particle sensor is not valid.

In FIG. 2, a second embodiment of a method according to the invention is illustrated.

The method according to FIG. 2 starts at step 200 and then proceeds to step 202 at which a differential pressure at the particle filter is sensed by the differential pressure sensor, which differential pressure is evaluated in the subsequent step 204.

If it is determined in step 204 that the sensed differential pressure is higher than a lower pressure threshold value, it can be inferred that the particle filter is operating correctly. Conversely, the particle filter can be diagnosed as faulty if the sensed differential pressure is lower than the lower pressure threshold value. Consequently, the method proceeds to step 230 and is ended if the sensed differential pressure is higher than the lower pressure threshold value.

If it is determined in step 204 that the sensed differential pressure is lower than a lower pressure threshold value, which indicates that the particle filter has a defect such as, for example, a hole of above-average size, the method proceeds to step 206 at which a quantity of particles is sensed by the particle sensor, and said quantity is evaluated in the subsequent step 208.

If it is determined in step 208 that the particle sensor is functionally capable, i.e. that the sensed quantity of particles is greater than a predetermined lower threshold value of the quantity of particles, the method proceeds to step 212, and the particle sensor is diagnosed as being functionally capable. In the subsequent step 220, it is possible to carry out the diagnostic method of the particle filter, which method has already been described with respect to the method step 120 in FIG. 1 and is ended in the subsequent step 230.

However, if it is determined in step 208 that the particle sensor is not functionally capable, i.e. that the sensed quantity of particles is smaller than the predetermined lower threshold value of the quantity of particles, the method proceeds to step 214, and the particle sensor is diagnosed as not being functionally capable. For this reason, the diagnostic method of the particle sensor according to method step 120 must or should not be carried out, for which reason at this point the method is already ended at step 230.

The functional capability of the particle sensor is tested by the method according to the invention before a diagnosis of the particle filter is carried out, which diagnosis is advantageously carried out by a particle sensor. Although the differential pressure signal of the differential pressure sensor is not sufficiently precise to diagnose the particle filter, it can be sufficient for the diagnosis of the functional capability of the particle sensor.

In particular, the upper and lower threshold values are to be used to test whether the respectably sensed parameters lie within the anticipated ranges. If this is not the case, corresponding statements can be made about the corresponding sensor or the corresponding component.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for testing a functional capability of a particle sensor arranged in an exhaust train of an internal combustion engine of a vehicle, wherein the internal combustion engine has a particle filter for at least partially capturing particles in exhaust gas, wherein the method comprises:
sensing a quantity of particles in the exhaust gas by the particle sensor arranged downstream of the particle filter and configured to sense a residual quantity of particles located in the exhaust gas;
determining if the sensed quantity of particles is greater than a predetermined upper threshold value of the quantity of particles;
sensing a differential pressure at the particle filter by a differential pressure sensor configured to sense a differential pressure at the particle filter between a pressure upstream of the particle filter and a pressure downstream of the particle filter; and
determining that the particle sensor is not functionally capable if the sensed differential pressure is higher than a predetermined upper pressure threshold value.

12. The method as claimed in claim 11, furthermore comprising:
burning off particles in and/or at the particle sensor if it is determined that the particle sensor is not functionally capable;
sensing a quantity of particles in the exhaust gas by the particle sensor after the burning off of particles; and
determining that the particle sensor is functionally capable again if the quantity of particles sensed after the burning off of particles is smaller than the predetermined upper threshold value of the quantity of particles.

13. The method as claimed in claim 11, further comprising:
burning off particles in and/or at the particle sensor if it is determined that the particle sensor is not functionally capable;
sensing a quantity of particles in the exhaust gas by the particle sensor after the burning off of particles; and
determining that the particle sensor is faulty if the quantity of particles sensed after the burning off of particles is greater than the predetermined upper threshold value of the quantity of particles.

14. The method as claimed in claim 11, further comprising:
performing a functional examination of the particle filter if the sensed differential pressure is lower than the predetermined upper pressure threshold value.

15. A method for testing a functional capability of a particle sensor arranged in an exhaust train of an internal combustion engine of a vehicle, wherein the internal combustion engine has a particle filter configured to at least partially capture particles in exhaust gas, wherein the method comprises:
sensing a differential pressure at the particle filter by a differential pressure sensor configured to sense a differential pressure at the particle filter between a pressure upstream of the particle filter and a pressure downstream of the particle filter;
determining that the sensed differential pressure is lower than a lower pressure threshold value;
sensing a quantity of particles in the exhaust gas by means of a particle sensor arranged downstream of the particle filter and configured to sense a residual quantity of particles located in the exhaust gas; and
determining that the particle sensor is not functionally capable if the sensed quantity of particles is smaller than a predetermined lower threshold value of the quantity of particles.

16. The method as claimed in claim 15, further comprising:
determining that the particle sensor is functionally capable if the sensed quantity of particles is greater than the predetermined lower threshold value of the quantity of particles.

17. The method as claimed in claim 16, wherein the predetermined upper pressure threshold value and/or the predetermined lower pressure threshold value are predetermined as a function of at least one of:
an exhaust mass flow located in the exhaust train and
a current load state of the particle filter.

18. The method as claimed in claim 16, wherein the predetermined upper threshold value of the quantity of particles and/or the predetermined lower threshold value of the quantity of particles are predetermined as a function of at least one of:
an exhaust mass flow located in the exhaust train and
a particle quantity raw emission.

19. A computer program product having a computer-readable medium and program code which is stored on the computer-readable medium which, when it is executed on a control unit, induces the control unit to execute a method comprising at least one of:
A) sensing a quantity of particles in an exhaust gas by a particle sensor arranged downstream of a particle filter and configured to sense a residual quantity of particles located in the exhaust gas;
determining if the sensed quantity of particles is greater than a predetermined upper threshold value of the quantity of particles;
sensing a differential pressure at the particle filter by a differential pressure sensor configured to sense a differential pressure at the particle filter between a pressure upstream of the particle filter and a pressure downstream of the particle filter; and
determining that the particle sensor is not functionally capable if the sensed differential pressure is higher than a predetermined upper pressure threshold value; and
B) sensing a differential pressure at the particle filter by a differential pressure sensor configured to sense a differential pressure at the particle filter between a pressure upstream of the particle filter and a pressure downstream of the particle filter;
determining that the sensed differential pressure is lower than a lower pressure threshold value;
sensing a quantity of particles in the exhaust gas by means of a particle sensor arranged downstream of the particle filter and configured to sense a residual quantity of particles located in the exhaust gas; and
determining that the particle sensor is not functionally capable if the sensed quantity of particles is smaller than a predetermined lower threshold value of the quantity of particles.

20. An exhaust train internal combustion engine, having:
a particle filter for at least partially capturing particles in an exhaust gas,
a differential pressure sensor for sensing a differential pressure at the particle filter between a pressure upstream of the particle filter and a pressure downstream of the particle filter,
a particle sensor arranged downstream of the particle filter and configured to sense a residual quantity of particles located in the exhaust gas, and
a control unit configured to obtain the differential pressure sensed by the differential pressure sensor and the quantities of particles sensed by the particle sensor and to execute a method for testing a functional capability of the particle sensor comprising at least one of:
A) sensing a quantity of particles in an exhaust gas by a particle sensor arranged downstream of a particle filter and configured to sense a residual quantity of particles located in the exhaust gas;
determining if the sensed quantity of particles is greater than a predetermined upper threshold value of the quantity of particles;
sensing a differential pressure at the particle filter by a differential pressure sensor configured to sense a differential pressure at the particle filter between a pressure upstream of the particle filter and a pressure downstream of the particle filter; and
determining that the particle sensor is not functionally capable if the sensed differential pressure is higher than a predetermined upper pressure threshold value; and
B) sensing a differential pressure at the particle filter by a differential pressure sensor configured to sense a differential pressure at the particle filter between a pressure upstream of the particle filter and a pressure downstream of the particle filter;
determining that the sensed differential pressure is lower than a lower pressure threshold value;
sensing a quantity of particles in the exhaust gas by means of a particle sensor arranged downstream of the particle filter and configured to sense a residual quantity of particles located in the exhaust gas; and
determining that the particle sensor is not functionally capable if the sensed quantity of particles is smaller than a predetermined lower threshold value of the quantity of particles.
